(19) United States
(12) Patent Application Publication
(10) Pub. No.: US 2011/0057616 A1
(43) Pub. Date: Mar. 10, 2011

(54) Battery Charging Circuit

(76) Inventors: Chia-Han Chan, Taipei (TW); Nan-Sheng Chang, Taipei (TW)

(21) Appl. No.: 12/556,572

(22) Filed: Sep. 10, 2009

(51) Int. Cl. H02J 7/00

(52) U.S. Cl. 320/116; 320/134; 320/163

(57) ABSTRACT

A battery charging circuit includes a power input unit for supplying power to charging units and a control module. Each charging unit includes a connecting port for connecting one battery, an electromagnetic coil and a switch module connected between the connecting port and the electromagnetic coil. The connecting ports are series-connected with one another. The control module is used for monitoring the voltage of the batteries and then controlling a work state of the switch modules by means of comparing a voltage variance between any two of the batteries with a specific data set in the control module so as to make the battery with a greatest voltage discharged to produce a discharge current for secondarily charging the other batteries by means of the electromagnetic coils when the voltage variance is greater than the specific data.

### BACKGROUND OF THE INVENTION

1. Field of the Invention

The present invention generally relates to a battery charging circuit, and more particularly to a battery charging circuit capable of effectively charging a plurality of series-connected rechargeable batteries.

2. The Related Art

A battery charging circuit used to charge a rechargeable battery often has a control function for preventing the rechargeable battery from being overcharged. That is to say, in the process of charging the rechargeable battery, if the voltage of the rechargeable battery is raised to a default value, the battery charging circuit will turn off a switch unit so as to terminate the charge process. Therefore the rechargeable battery can avoid being damaged by overcharging.

However, when the above-mentioned battery charging circuit is used to charge a plurality of series-connected rechargeable batteries, if the remained power in each of the rechargeable batteries differs from one another, then the rechargeable battery having a more remained power therein will be charged to easily make the voltage thereof raised to the default value firstly. At this time, the battery charging circuit will turn off the switch unit so as to protect the corresponding rechargeable battery from being overcharged that prevents the battery charging circuit from charging other rechargeable batteries. Therefore, when the charge process is terminated, some rechargeable batteries are not charged completely to be raised to the default value that will reduce the time of supplying power of the rechargeable batteries and speed up aging the rechargeable battery. Therefore, a battery charging circuit capable of overcoming the foregoing problems is required.

### SUMMARY OF THE INVENTION

An object of the present invention is to provide a battery charging circuit adapted for charging a plurality of series-connected rechargeable batteries. The battery charging circuit includes a plurality of charging units, a control module and a power input unit for supplying power to the charging units and the control module. Each of the charging units includes a connecting port for connecting one battery, an electromagnetic coil and a switch module connected between the connecting port and the electromagnetic coil. The connecting ports of the charging units are series-connected with one another. The control module is used for monitoring the voltage of the batteries and then controlling a work state of the switch modules by means of comparing a voltage variance between any two of the batteries with a specific data set in the control module so as to make the battery with a greatest voltage discharged to produce a discharge current for secondarily charging the other batteries by means of the electromagnetic coils when the voltage variance is greater than the specific data. So that retards the ageing of the batteries and further ensures each of the batteries charged completely and effectively.

### BRIEF DESCRIPTION OF THE DRAWINGS

The present invention will be apparent to those skilled in the art by reading the following description, with reference to the attached drawings, in which:

FIG. 1 is a circuitry of a battery charging circuit of the present invention.

### DETAILED DESCRIPTION OF THE PREFERRED EMBODIMENT

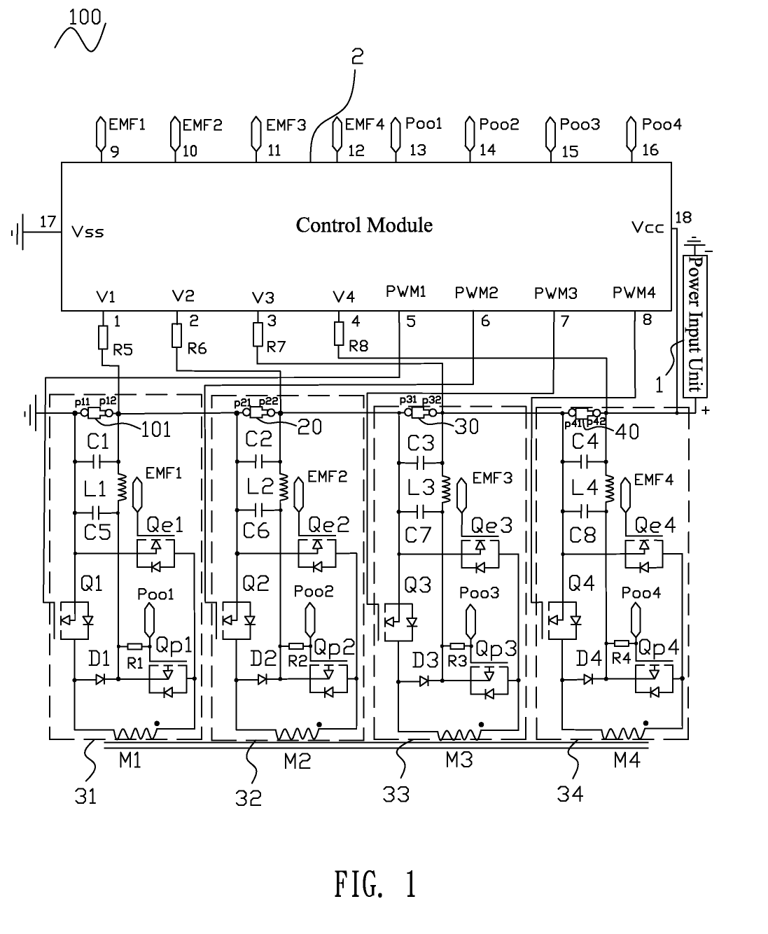

With reference to FIG. 1, a battery charging circuit 100 according to the present invention is shown. The battery charging circuit 100 includes a power input unit 1, a control module 2 and a plurality of charging units. In this embodiment, there are four of the charging units respectively designated as a first charging unit 31, a second charging unit 32, a third charging unit 33 and a fourth charging unit 34. The power input unit 1 is connected with an external power supply (not shown) so as to supply power to the control module 2 and the charging units 31˜34.

The control module 2 has a monitoring and control function for the charging units 31˜34. A Vcc port of the control module 2 is connected with the power input unit 1 for gaining a working voltage from the power input unit 1, and a Vss port thereof is connected to ground. The control module 2 further has a plurality of monitoring ports and control ports. In the embodiment, the monitoring ports include a first monitoring port V1, a second monitoring port V2, a third monitoring port V3 and a fourth monitoring port V4; the control ports have four groups each including a first control port designated as PWM1˜PWM4, a second control port designated as Poo1˜Poo4 and a third control port designated as EMF1˜EMF4.

The first charging unit 31 includes a connecting port for connecting a first rechargeable battery 101, a π filter, a switch module and an electromagnetic coil M1. The a filter includes two parallel capacitors C1, C5 one of which is connected to the connecting port and a series inductance L1. The connecting port includes a positive connecting point p12 connected to the first monitoring port V1 of the control module 2 through a first resistor R5 and a negative connecting point p11 connected to ground, so the voltage of the first rechargeable battery 101 can be monitored by the first monitoring port V1 of the control module 2. The switch module includes a diode D1, a resistance element R1, a first switch element Q1, a second switch element Qp1 and a third switch element Qe1. In the embodiment, the first switch elements Q1 and the third switch element Qe1 are an N-channel FET respectively, and the second switch element Qp1 is a P-channel FET. The sources of the first switch element Q1 and the third switch element Qe1 are connected with the negative connecting point p11. The drain of the first switch element Q1 is on one hand connected to the drains of the second switch element Qp1 and the third switch element Qe1 through the electromagnetic coil M1, and on the other hand, connected to the source of the second switch element Qp1 through the diode D1. The grid of the first switch element Q1 is connected with the first control port PWM1 of the control module 2, and the grid of the third switch element Qe1 is connected with the third control port EMF1 of the control module 2, so the switch state of the first and third switch elements Q1, Qe1 can be respectively controlled by the first and third control ports PWM1, EMF1. The source of the second switch element Qp1 is further on one hand connected to the positive connecting point p12 through the inductance L1, and on the other hand, connected to the grid thereof through the resistance element R1. The grid of the second switch element Qp1 is further connected with the second control port Poo1 of the control module 2, so the connection and the disconnection of the second switch element Qp1 can be controlled by the second control port Poo1.

The second, third and fourth charging units 32˜34 each has the same circuitry as the first charging unit 31, and includes a connecting port which includes a positive connecting point designated as p22, p32, p42 and a corresponding negative connecting point designated as p21, p31, p41, a π filter which includes two capacitors designated as C2 and C6, C3 and C7, C4 and C8 and an inductance designated as L2, L3, L4, a switch module and an electromagnetic coil designated as M2, M3, M4. Each of the switch modules of the second, third and fourth charging units 32˜34 includes a diode designated as D2, D3, D4, a resistance element designated as R2, R3, R4, a first switch element designated as Q2, Q3, Q4, a second switch element designated as Qp2, Qp3, Qp4, and a third switch element designated as Qe2, Qe3, Qe4. The connecting ports of the second, third and fourth charging units 32˜34 are respectively used to connect a second rechargeable battery 20, a third rechargeable battery 30 and a fourth rechargeable battery 40. The positive connecting points p22, p32, p42 are respectively connected to the second, third and fourth monitoring ports V2, V3, V4 of the control module 2 through a second, third and fourth resistor R6, R7, R8. The connecting ports of the charging units 31˜34 are series-connected with one another, and the outmost positive connecting point p42 of the fourth charging unit 34 is connected with the power input unit 1. The grids of the first switch elements Q2, Q3, Q4 of the second, third and fourth charging units 32˜34 are respectively connected with the first control ports PWM2, PWM3, PWM4 of the control module 2, the grids of the second switch elements Qp2, Qp3, Qp4 thereof are respectively connected with the second control ports Poo2, Poo3, Poo4, and the grids of the third switch elements Qe2, Qe3, Qe4 thereof are respectively connected with the third control ports EMF2, EMF3, EMF4. The electromagnetic coils M1˜M4 of the charging units 31˜34 are wound around only one core (not labeled) in the same direction for strengthening the magnetic field intensity when there is current flowed therethrough.

When the battery charging circuit 100 charges the series-connected rechargeable batteries 101, 20, 30, 40, the control module 2 controls all of the switch modules of the four charging units 31˜34 off. At the same time, the control module 2 utilizes the monitoring ports V1˜V4 to respectively monitor the voltage of the corresponding rechargeable batteries 101, 20, 30, 40. When the voltage variance between any two of the rechargeable batteries 101, 20, 30, 40 is monitored by the control module 2 to be greater than a specific data set in the control module 2, the working principle of the battery charging circuit 100 is described hereinafter. Now take description to the working principle of the battery charging circuit 100 provided that the first rechargeable battery 101 has a highest voltage. At this moment, the control module 2 controls the switch module of the first charging unit 31 to be in a discharging state, that is to say, the first control port PWM1 controls the first switch element Q1 continually connected and disconnected, the second control port Pool controls the second switch element Qp1 connected and the third control port EMF1 controls the third switch element Qe1 disconnected so as to make the first rechargeable battery 101 discharged by means of the electromagnetic coil M1. Simultaneously, the control module 2 controls the switch modules of the second, third and fourth charging units 32˜34 to be in a secondary charging state, namely the first switch elements Q2˜Q4 and the second switch elements Qp2˜Qp4 being disconnected and the third switch elements Qe2˜Qe4 being connected so as to make the second, third and fourth rechargeable batteries 20, 30, 40 charged by means of the corresponding electromagnetic coils M2˜M4.

When the first rechargeable battery 101 is discharged to produce a discharge current, the discharge current will substantially flow in the following direction: the positive connecting point p12→the second switch element Qp1→the electromagnetic coil M1→the first switch element Q1→the negative connecting point p11. As a result, the discharge current is partially transformed into magnetic energy through the electromagnetic coil M1, then the magnetic energy is newly transformed into electrical energy by means of the electromagnetic coils M2˜M4 so as to charge the second, third and fourth rechargeable batteries 20, 30, 40 through the corresponding diodes D2˜D4 and the corresponding third switch elements Qe2˜Qe4 respectively until the voltage variance between the first rechargeable battery 101 and each of the second, third and fourth rechargeable batteries 20, 30, 40 is re-monitored by the control module 2 to be smaller than the specific data. At this time, the control module 2 re-controls all of the switch modules of the charging units 31˜34 to be disconnected to make the rechargeable batteries 101, 20, 30, 40 continuatively charged by the power input unit 1.

The working principle of the control module 2 controlling the second, third and fourth charging units 32˜34 is the same as the one of controlling the first charging unit 31, so it will not be described any more. When all of the series-connected rechargeable batteries 101, 20, 30, 40 are fully charged, the charge process of the battery charging circuit 100 is stopped by the control module 2.

As described above, the battery charging circuit 100 of the present invention utilizes the control module 2 to control the work state of the switch modules of the charging units 31˜34 according to the compared result of the voltage variance between the any two of the series-connected rechargeable batteries 101, 20, 30, 40 and the specific data, and then utilizes the electromagnetic coils M1˜M4 to transfer the electrical energy of the rechargeable battery with the greatest voltage to the other rechargeable batteries so that retards the ageing of the rechargeable battery and further ensures each of the rechargeable batteries 101, 20, 30, 40 charged completely and effectively.

What is claimed is:

1. A battery charging circuit adapted for charging a plurality of series-connected rechargeable batteries, comprising:
a plurality of charging units each including a connecting port for connecting one battery, an electromagnetic coil and a switch module connected between the connecting port and the electromagnetic coil, the connecting ports of the charging units being series-connected with one another;
a control module for monitoring the voltage of the batteries and then controlling a work state of the switch modules by means of comparing a voltage variance between any two of the batteries with a specific data set in the control module so as to make the battery with a greatest voltage discharged to produce a discharge current for secondarily charging the other batteries by means of the electromagnetic coils when the voltage variance is greater than the specific data; and
a power input unit for supplying power to the charging units and the control module.

2. The battery charging circuit as claimed in claim 1, wherein the control module controls all of the switch modules to be disconnected to make the batteries charged by the power input unit when the voltage variance is smaller than the specific data.

3. The battery charging circuit as claimed in claim 1, wherein the switch module of the charging unit having the greatest voltage is controlled in a discharging state to make the discharge current flow through the corresponding electromagnetic coil to be transformed into magnetic energy, the electromagnetic coils of the other charging units transform the magnetic energy into electrical energy and the corresponding switch modules each are controlled in a secondary charging state to make the respective batteries charged by the transformed electrical energy.

4. The battery charging circuit as claimed in claim 3, wherein the connecting port includes a positive connecting point and a negative connecting point, the switch module includes a diode and three FETs acted as a first switch element, a second switch element and a third switch element, the sources of the first and third switch elements are connected with the negative connecting point, the drain of the first switch element is connected to the drains of the second and third switch elements through the corresponding electromagnetic coil, the source of the second switch element is connected to the positive connecting point and the grid thereof respectively, the grids of the first, second and third switch elements are connected with the control module respectively, the drain of the first switch element is further connected to the source of the second switch element through the diode.

5. The battery charging circuit as claimed in claim 4, wherein the discharging state is that the first switch element is controlled to be continually connected and disconnected, the second switch element is connected and the third switch element is disconnected, the secondary charging state is that the first switch element and the second switch element are disconnected and the third switch element is connected.

6. The battery charging circuit as claimed in claim 4, wherein the switch module further includes a resistance element connected between the source and the grid of the second switch element.

7. The battery charging circuit as claimed in claim 1, wherein the electromagnetic coils of the charging units are wound around only one core in the same direction.

8. The battery charging circuit as claimed in claim 1, wherein each of the charging units further includes a filter parallel-connected to the respective connecting port.

9. The battery charging circuit as claimed in claim 8, wherein the filter is a π filter which includes two parallel capacitors and an inductance.
